(19) United States
(12) Patent Application Publication
(10) Pub. No.: US 2026/0069905 A1
(43) Pub. Date: Mar. 12, 2026

(54) SAFETY SHUTDOWN DEVICE WITH FIRE-EXTINGUISHING SYSTEM

(71) Applicant: Yuriy Alexandrovich Gabliya, Moscow (RU)

(72) Inventor: Evgenii Sergeevich KAPLUN, s. Malaya (RU)

(21) Appl. No.: 18/870,991

(22) PCT Filed: Jun. 1, 2023
(86) PCT No.: PCT/RU2023/000161

§ 371 Date: Dec. 2, 2024

(30) Foreign Application Priority Data
Jun. 2, 2022 (RU) 2022115004

(51) Int. Cl. A62C 3/16; H02H 5/04

(52) U.S. Cl. CPC A62C 3/16; H02H 5/045

(57) ABSTRACT

The claimed safety shutdown device can be used for the timely emergency shutdown of electrical equipment under the effect of high temperatures, for example in the event of a fire, as well as in the event of an overload or a short circuit. The safety shutdown device comprises a housing, and an aerosol module (12) containing an aerosol-forming or gas-forming composition, which projects beyond said housing. Disposed on the projecting portion of the module is a self-combusting heat-sensitive igniter (22) with a trigger temperature that is lower than the trigger temperature of the aerosol module (12). The safety shutdown device further comprises a heat-sensitive shutdown device (8), a contact group (18) for supplying an external trigger signal, an activation sensor (21), and a button (25) for manually activating an electrical igniter. The technical result consists in increasing the timeliness of an initial fire-extinguishing action and more efficiently impeding the spread of fire in an enclosed space.

### PERTINENT ART

The claimed group of inventions belongs to the electrical engineering and energy field and can be used as a differential circuit breaker (safety shutdown device) or input differential circuit breaker (input safety shutdown device) of the electrical control panel for the prevention of electric shock to a person, quick emergency shutdown of the electrical equipment by means of the differential interrupter without triggering fire-extinguishing system or on exposure to high temperatures, for example, in case of fire, triggering aerosol-forming or gas-forming fire-extinguishing systems (extinguishing the fire source by using aerosol-forming or gas-forming composition simultaneously interrupting the line through differential circuit breaker mechanism). The device is designed providing the ability to be installed on a DIN rail.

### PRIOR ART

Patent prior art suggests a solution, which is a differential circuit breaker (safety shutdown device) installed into the electrical control panel on DIN rail, and performing the function of protecting human from the electric shock in case of electric current leakage. For example, Schneider Electric casting housing differential circuit breakers for 16-630 A currents, up to 690 V, product catalogue of 2021 (available online, web resource https://download.schneider-electric.com).

However, such prior art solution do not provide interruption of power circuits in case of ignition of the electrical control panels, and are unable to extinguish fire in electrical control panels.

Patent prior art suggests a solution, which is a pyrotechnic interrupter of the electric circuit (RU 139706 U1, 20.04.2014). Prior art circuit breaker includes housing, inside which conductor and pyrotechnic charge, which has the melting temperature of the conductor below the combustion temperature of the pyrotechnic charge, are located in direct proximity or in joint, and pyrotechnic charge is set up using the thermal cord or from the fire alarm unit.

Technical result, which the specified solution is aimed for, involves reliable interruption of the electric circuit (disconnection of the power supply source), in case of fire or threat of fire, in order to prevent the spread of fire due to a short circuit.

However, prior art solution, as well as the solution specified above, do not provide opportunity to eliminate the fire source. Moreover, performance of the breaker when activated by the fire alarm unit depends on the functional capability of the external means, which reduces the reliability of operation.

It should be noted, that prior art solution lacks activating efficiency, because the activation temperature of the thermal cord is required for its operation, moreover, the source of the temperature is external, i.e. it is provided by the fire source. It is obvious that until the required temperature is reached, the fire will spread unchecked, which can cause damage to the equipment nearby.

In order to provide both, the breaking of the circuits and the implementation of primary automatic fire-extinguishing in the prior art, a combination of a means for breaking and fire-extinguishing are used, as it is introduced in the patent source CN 210040091 U, 07.02.2020.

This solution suggests the automatic circuit breaker contains a main housing with a container with a fire-extinguishing composition airblower installed to it. Control of activation of the airblower and spraying of the fire-extinguishing composition is provided upon reaching certain temperature due to the thermal key, which is located on the circuit breaker housing.

Prior art solution eliminates the disadvantages of the prior art mentioned above, in terms of providing the primary fire-extinguishing function. Nevertheless, prior art solution has a number of disadvantages, such as the following.

Complexity and unwieldiness of the structure of the circuit breaker mentioned above prevents its placement in a standard housing of electrical devices for the installation on the DIN rail in electrical control panel. But it is critically important to install means capable to extinguish source of the fire in the electrical control panel, as fire spreads rapidly inside the enclosed space of the electrical control panel with assembled electrical modules, and it can lead to the occurrence of secondary fire sources due to the short circuit of the cords with burnt or melted insulation, and to permanent damage of the modules.

In addition, prior art solution, and the solution described above under the patent RU 139706 U1, lacks activating efficiency because the activation temperature of the thermal cord is required for its operation, moreover, the source of the temperature is external, i.e. it is provided by the fire source. Therefore, until the fire-extinguishing mean is activated, electrical modules located in the electrical control panel can be significantly damages.

Patent prior art suggests a solution, which is autonomous fire-extinguishing device for installation on DIN rail (useful model patent No. 204767 dated 09.06.21). Common device consists of a housing, where the fire-extinguishing aerosol generator module with thermo-chemical trigger is located.

Prior art solution eliminates the disadvantages of the prior art mentioned above, in terms of providing the primary fire-extinguishing function. Nevertheless, prior art solution has a number of disadvantages, such as the following.

Autonomous device is made in the form of a separate module and cannot interrupt electric power lines, which significantly increases the opportunity of re-ignition of electrical wiring in electrical cabinets, and increases the opportunity of electric shock to people, moreover, the autonomous device cannot be triggered by the external control signal and it does not generate an information signal about triggering, which does not allow to assemble autonomous devices into groups or inform about the beginning of the fire-extinguishing process.

The technical problem is to overcome the disadvantages of analogues specified above.

The technical result consists in improving the timeliness of an initial fire-extinguishing action and more effectively impeding the spread of fire in an enclosed space such as, in particular, an electrical control panel, while simultaneously interrupting an electrical circuit, at the same time, the described device can interrupt the electrical circuit in case of electrical current leakage without triggering aerosol-forming or gas-forming fire-extinguishing system, acting like a standard differential circuit breaker (safety shutdown device) for for single-phase or three-phase connections.

### DISCLOSURE OF INVENTION

Specified technical result is reached by the differential circuit breaker (safety shutdown device) in single-phase or three-phase versions, with installed aerosol-forming or gas-forming composition (aerosol module), which contains a housing and an aerosol module (12) different by protruding over the housing and containing on the edge a self-igniting thermal igniter (22) which triggering temperature is below the aerosole module; it contains the power electrical terminals for single-phase or three-phase connection (14-14′), electrical terminals (13-13′) for connecting the neutral cable, electrical igniter of the aerosol module (9) installed to the housing.

In the alternative version the device additionally contains the shutdown heat-sensitive device (8), contact group (18) for supplying an external trigger signal, an activation sensor (21), and a button (25) for manually activating the aerosol module (9); electrical igniter of the aerosol module (9) is connected trough the conductors with the contact group (18) for supplying an external trigger signal; shutdown heat-sensitive device (8) is installed in direct proximity to the aerosol module or inside the aerosol module and is connected trough the conductors with phase and neutral automatic shutdown mechanisms; an activation sensor (21) is installed in direct proximity to the aerosol module or inside the aerosol module, connected with the conductors (20) and the contact group (18); a button (25) for manually activating the electrical igniter is connected to the electrical igniter of the aerosol module (9).

In the alternative version of the device, aerosol-forming or gas-forming composition is a low-temperature solid fuel composition.

In the alternative version of the device, the housing is made in a form of a standard modular-type electrical device, and a circuit breaker additionally designed to be installed on DIN rail, DIN rail fastening is a cut slot for DIN rail, which is located on the back side of the device housing, where a coupling is installed to fix the housing on DIN rail.

In preferred version of the device there are additional cut slots in the housing for discharge of aerosol-forming or gas-forming composition.

Further on the description provides information regarding the implementation of the device and confirmation of the achievement of the specified technical result.

### IMPLEMENTATION OF INVENTION

In accordance with the variants of the device, further the information is given concerning the preferred variant of the implementation of the device, which is not intended to limit the scope of the sought protection, defined by the independent claim signs.

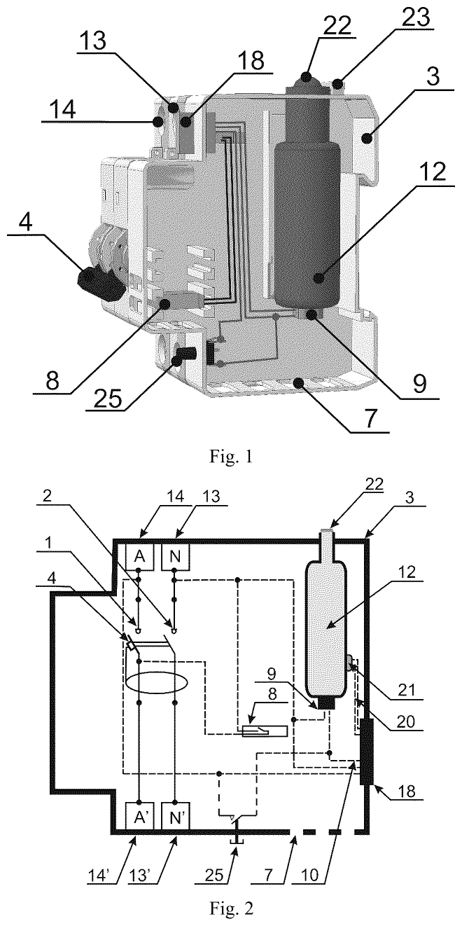

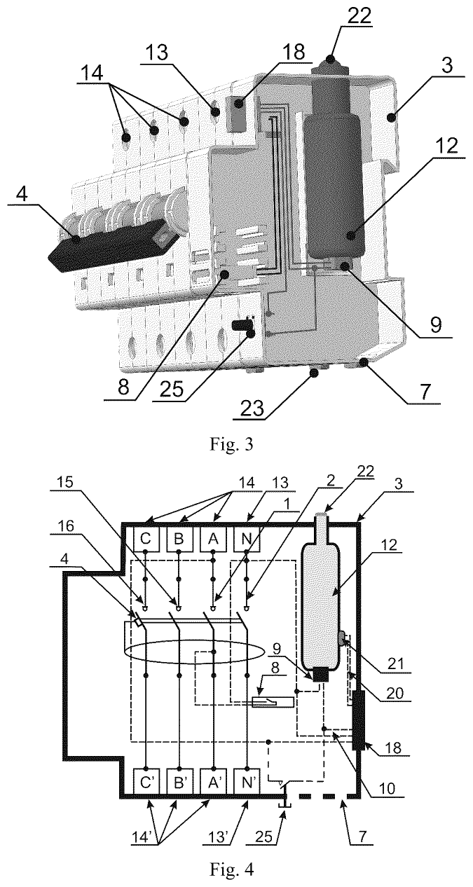

For better understanding of the essence of the patent, references are made to the explanatory draft in the description (FIG. 1, FIG. 2, FIG. 3, FIG. 4) according to which the appearance of the housing with a section in single-phase and three-phase versions is presented (FIG. 1, FIG. 3) scheme of safety shutdown device with an aerosol-forming or gas-forming composition aerosol module in single-phase and three-phase versions (FIG. 2, FIG. 4), as well as a set of elements in single-phase and three-phase versions, which are installed in the differential circuit breaker (FIG. 1, FIG. 2, FIG. 3, FIG. 4)

In preferred version of performance the suggested device is installed on DIN rail in the electrical cabinet, and is an independent device, for which the housing can be made in a form of standard modular-type electrical device. The device can be use in single-phase or three-phase connections. As per FIG. 1 and FIG. 2, the housing of the device has: a pair of phase terminals (14-14′) and a pair of zero terminals (13-13′). Phase and neutral N automatic shutdown mechanism (4), power cables of phases, neutral cable N (2) are connected to the device through phase terminals and zero terminals. As per FIG. 1 and FIG. 2 on the housing there are two output holes (7) for discharge of the aerosol-forming or gas-forming composition, which forms during the operation of the device.

Phase and neutral N automatic shutdown mechanisms (4) are installed mainly in the center of the housing, and in the side housing aerosol module (12) with an electrical igniter of aerosol module (9) is installed. Aerosol-forming or gas-forming fire-extinguishing systems are widespread in the prior art. The principle of action of the aerosol-forming composition can be considered as an example, based on the inhibition of chemical processes occurring in the flame, highly dispersive particles (aerosol) of alkali salt, released during the combustion of an aerosol-forming charge and that can be in a suspended state for a long time, which ensures the elimination of the fire source. At the same time, it is known that during the operation of the aerosol-forming composition, a zone with a significantly elevated temperature (for example above 300° C.) is provided around it. This effect is used in the device to increase timeliness of primary fire-extinguishing while increasing the effectiveness of prevention of the spread of fire in the enclosed space, and triggering of phase and neutral N automatic shutdown mechanism (4).

Near aerosol module (12) or in aerosol module (12) shutdown heat-sensitive device (8) can be installed in the housing of the device (it can be performed with an electrical power supply and control module-is not shown) as per FIG. 1 and FIG. 2, which is responsible for the formation of signal for shutdown of automatic shutdown of the phase and neutral N (4) in case of ignition of the electrical control panel and activation of aerosol module (12) using a self-igniting thermal igniter (22). Distance from the shutdown heat-sensitive device (8) to aerosol module (12) is in such a way that when the aerosol module (12) is triggered the resulting temperature could provide activation of the shutdown heat-sensitive device (8) due to the overheating (for example, at 100° C.), thereby interrupting the shutdown heat-sensitive device (8) and forming a shutdown signal of phase and neutral N automatic shutdown mechanism (4). Thereby, a term “direct proximity” for the purpose of the application should be understood by the placement in which the heat coming from the operating aerosol module (12) could provide the operation of the shutdown heat-sensitive device (8). Further, as per FIG. 1 and FIG. 2, a self-igniting thermal igniter (22) is applied to the aerosol module (12), protruding over the housing (3).

The suggested device works as the following way.

Under normal conditions as per FIG. 1 and FIG. 2, phase terminals (14-14′) are connected to the phase and neutral N automatic shutdown mechanism (4). Therefore, the flow of electric current through the circuit is provided. Terminal (14)—Conductor (1)—Phase and neutral N automatic shutdown mechanism (4)—Conductor—Terminal (14). Zero terminals (13-13′) are connected with each other by the relevant conductors through phase and neutral N automatic shutdown mechanism (4). In case of increase of temperature in the electrical control panel (ignition of the electrical control panel), where the device is installed, up to the established critical value, determined by the parameters of the self-igniting thermal igniter (22), self-igniting thermal igniter (22) is being triggered, which leads to start of operation of the aerosol module (12). At the beginning of the operation of the aerosol module (12) from the housing (3) trough output holes (7) as per FIG.
1 and FIG. 2 erosol-forming or gas-forming composition is discharged in a form of a gaseous mixture, filling the protected scope of the electrical control panel and suppressing the burnings of the electrical control panel components. Simultaneously, around the aerosol module (12) or inside the aerosol module (12) a heating zone is formed up to a temperature of, for example, over 300° C., by actuating with its heat current the shutdown heat-sensitive device (8), which, when heated above the self-triggering overheating temperature (for example, over 100° C.), triggers, thereby forming an interruption signal for the phase and neutral N automatic shutdown mechanism (4).

Therefore, upon activation of the self-igniting thermal igniter (22) as per FIG. 1 and FIG. 2, during ignition of the electrical control panel fire in the electrical control panel is extinguished by the aerosol module (12) and the interruption of phase cable (1, 15, 16) on the phase terminals line (14-14′) and neutral cable N (2) on the zero terminal line N (13-13′) as per FIG. 1 and FIG. 2, which can be considered an advantage of the suggested device compared to solutions of the state of the art.

The use of the aerosol module (12) as a device for the activation of input differential circuit breaker (input safety shutdown device) provides the acceleration of electrical circuits interruption prior to the current leakage, preventing the occurrence of secondary fire sources, because the time needed to reach the temperature for activation of shutdown heat-sensitive device (8) is significantly less due to the aerosol module (seconds), rather than if the activation of shutdown heat-sensitive device (8) would be provided due to the heat of an external source (i.e. a fire source).

Therefore, only through the use of the above-mentioned means and their functioning through these connections in conjunction, it is possible to achieve a technical result, to which the suggested device is aimed.

The device can be implemented with the help of the means and methods known to specialists from the prior art, and analysis of the prior art did not discovered the solutions, which would have all the significant signs specified in the claim. As per the alternative variant of the device in order to better understand the essence of the patent, in the description there are references given to the explanatory draft (FIG. 3, FIG. 4) according to which the appearance of the housing with a section in three-phase versions (FIG. 3), a scheme of a differential circuit breaker (safety shutdown device) with aerosol-forming or gas-forming composition and aerosol module in three-phase versions (FIG. 4) are presented.

As per FIG. 3 and FIG. 4, the housing of the device has: three pairs of phase terminals A, B, C (14-14′) and a pair of zero terminals (13-13′). Phase and neutral N automatic shutdown mechanism (4), power cables of phases A, B, C (1, 15, 16), neutral cables N (2) are connected to the device through phase terminals and zero terminals. On the housing as per FIG.
3 and FIG. 4 there are output holes (7) for discharge of the aerosol-forming or gas-forming composition, which forms during the operation of the device.

Phase and neutral N automatic shutdown mechanism (4) are installed mainly in the center of the housing, and in the side housing aerosol module (12) with an electrical igniter of aerosol module (9) is installed. Aerosol-forming or gas-forming fire-extinguishing systems are widespread in the prior art. The principle of action of the aerosol-forming composition can be considered as an example, based on the inhibition of chemical processes occurring in the flame, highly dispersive particles (aerosol) of alkali
salt, released during the combustion of an aerosol-forming charge and that can be in a suspended state for a long time, which ensures the elimination of the fire source. At the same time, it is known that during the operation of the aerosol-forming composition, a zone with a significantly elevated temperature (for example above 300° C.) is provided around it. This effect is used in the device to increase timeliness of primary fire-extinguishing while increasing the effectiveness of prevention of the spread of fire in the enclosed space, and triggering of phase and neutral N automatic shutdown mechanism (4).

Near aerosol module (12) or in aerosol module (12) shutdown heat-sensitive device (8) can be installed in the housing of the device (it can be performed with an electrical power supply and control module-is not shown) as per FIG. 3 and FIG. 4, which is responsible for the formation of signal for shutdown of automatic shutdown of the phase and neutral N (4) in case of ignition of the electrical control panel and triggering of aerosol module (12) using a self-igniting thermal igniter (22). Distance from the shutdown heat-sensitive device (8) to aerosol module (12) is in such a way that when the aerosol module (12) is triggered the resulting temperature could provide activation of the shutdown heat-sensitive device (8) due to the overheating (for example, at 100° C.), thereby interrupting the shutdown heat-sensitive device (8) and forming a shutdown signal of phase and neutral N automatic shutdown mechanism (4). Thereby, a term “direct proximity” for the purpose of the application should be understood by the placement in which the heat coming from the operating aerosol module (12) could provide the operation of the shutdown heat-sensitive device (8). Further, as per FIG. 3 and FIG. 4, a self-igniting thermal igniter (22) is applied to the aerosol module (12), protruding over the housing (3).

The suggested device works as the following way.

Under normal conditions as per FIG. 3 and FIG. 4 phase terminals (14-14′) are connected to the phase and neutral N automatic shutdown mechanism (4). Therefore, the flow of electric current through the circuit is provided: Terminal (14)—Conductor (1)—Phase and neutral N automatic shutdown mechanism (4)—Conductor—Terminal (14′), Terminal (14)—Conductor (15)—Phase and neutral N automatic shutdown mechanism (4)—Conductor—Terminal (14′), Terminal (14)—Conductor (16) Phase and neutral N automatic shutdown mechanism (4)—Conductor—Terminal (14′). Zero terminals (13-13′) are connected with each other by the relevant conductors through phase and neutral N automatic shutdown mechanism (4).

In case of increase of temperature in the electrical control panel (ignition of the electrical control panel), where the device is installed, up to the established critical value, determined by the parameters of the self-igniting thermal igniter (22), self-igniting thermal igniter (22) is being triggered, which leads to start of operation of the aerosol module (12). At the beginning of the operation of the aerosol module (12) from the housing (3) trough output holes (7) as per FIG. 3 and FIG. 4 aerosol-forming or gas-forming composition is discharged in a form of a gaseous mixture, filling the protected scope of the electrical control panel and suppressing the burnings of the electrical control panel components. Simultaneously, around the aerosol module (12) or inside the aerosol module (12) a heating zone is formed up to a temperature of, for example, over 300° C., by actuating with its heat current the shutdown heat-sensitive device (8), which, when heated above the self-triggering overheating temperature (for example, over 100° C.), triggers, thereby forming an interruption signal for the phase and neutral N automatic shutdown mechanism (4).

Therefore, upon activation of the self-igniting thermal igniter (22) as per FIG. 3 and FIG. 4, during ignition of the electrical control panel fire in the electrical control panel is extinguished by the aerosol module (12) and the interruption of phase cables of phases A, B, C (1, 15, 16) on the phase terminals line 14-14′) and neutral cable N (2) on the zero terminal line N (13-13′) as per FIG. 3 and FIG. 4, which can be considered an advantage of the suggested device compared to solutions of the state of the art.

The use of the aerosol module (12) as a device for the activation of input differential circuit breaker (input safety shutdown device) provides the acceleration of electrical circuits interruption prior to the current leakage, preventing the occurrence of secondary fire sources, because the time needed to reach the temperature for activation of shutdown heat-sensitive device (8) is significantly less due to the aerosol module (seconds), rather than if the activation of shutdown heat-sensitive device (8) would be provided due to the heat of an external source (i.e. a fire source).

Therefore, only through the use of the above-mentioned means and their functioning through these connections in conjunction, it is possible to achieve a technical result, to which the suggested device is aimed.

The device can be implemented with the help of the means and methods known to specialists from the prior art, and analysis of the prior art did not discovered the solutions, which would have all the significant signs specified in the claim. It should also be noted, that the device in preferable variant contains input contact group (18), which allows upon supplying a signal to it, activate the electrical igniter of the aerosol module (9) through the conductors (10) using an external signal. In alternative variant the device has a button (25) for manually activating an electrical igniter of the aerosol module (9). When pressing the manual start button (25), electrical igniter of the aerosol module (9) connects directly to phase and neutral N (2), which allows to trigger electrical igniter of the aerosol module (9) in manual mode.

In alternative version, the device contains activation sensor (21), which through the conductors (20) sends a signal to the contact group (18) (additional contacts) about triggering of aerosol-forming or gas-forming composition for processing of the received signal with external control automation.

In preferred version of the device, the back side of the housing (3) has a cut spot, where a coupling (23) is installed in order to fix the housing (3) on DIN rail.

In alternative variant the housing of the device can be installed on DIN rail with screwed joint, but it is more preferable to install it through the adjuster for DIN rail with a lock (23), because it makes it possible to install the device in a larger range of places in a control panel or cabinet, which leads to an increase of the efficiency of fire extinguishing.

A distinctive feature of the device is an ability to shutdown the power part of the electrical control panel in case of current leakage without triggering the aerosol module (12), and a possibility of subsequent triggering of a differential circuit breaker (safety shutdown device) to the initial state by means of phase and neutral N automatic shutdown mechanism (4) and subsequent operation of the device.

The device can be implemented with the help of the means and methods known to specialists from the prior art, and analysis of the prior art did not discovered the solutions, which would have all the significant signs specified in the claim.

1. Safety shutdown device, consisting of a housing and an aerosol module (12) with aerosol-forming or gas-forming composition is different by the module (12) protruding over the housing and contains on the edge a self-igniting thermal igniter (22), which triggering temperature is below the module (12) triggering temperature, and it additionally contains shutdown heat-sensitive device (8), contact group (18) ) for supplying an external trigger signal, an activation sensor (21), and a button (25) for manually activating an electrical igniter.

2. Safety shutdown device as per item 1, is different by the aerosol module (12), protruding over the housing being made in a form of a thermal cord.

3. Safety shutdown device as per item 1, is different by electrical igniter of aerosol module (9) being connected through the conductors with the contact group (18) for the triggering of the external signal; shutdown heat-sensitive device (8) is connected through the conductors to the phase automatic shutdown mechanism of any phase A, B, C in three-phase versions and phase A in single-phase version, and neutral shutdown mechanism; an activation sensor (21) is connected through the conductors (20) with a contact group (18); a manual start button (25) for the electric igniter is connected with the electric igniter of the aerosol module (9)

4. Safety shutdown device as per item 1, is different by the aerosol-forming or gas-forming composition, which is a low-temperature solid fuel composition.

5. Safety shutdown device as per item 1, is different by the housing made in a form of a modular-type electrical device, and a circuit breaker additionally designed to be installed on DIN rail, DIN rail fastening is a cut slot for DIN rail, which is located on the back side of the device housing, where a coupling is installed to fix the housing on DIN rail.
